(19) United States
(12) Patent Application Publication
(10) Pub. No.: US 2025/0091843 A1
(43) Pub. Date: Mar. 20, 2025

(54) Hunting Hoist

(71) Applicant: Earl Miller, Oklahoma City, OK (US)

(72) Inventor: Earl Miller, Oklahoma City, OK (US)

(21) Appl. No.: 18/468,472

(22) Filed: Sep. 15, 2023

(51) Int. Cl. B66D 3/04; A01M 31/02; F41A 23/02

(52) U.S. Cl. CPC B66D 3/04; A01M 31/02; F41A 23/02

(57) ABSTRACT

An improved hunting hoist adapted to be mounted at an elevated location for hoisting supplies or other equipment. The improved hunting hoist includes a first arm, a second arm, and a pulley system. The first arm has a first fastener, and the second arm has a second fastener—the fasteners for engaging a tree or similar structure. A pulley system is mounted to the improved hunting hoist. The improved hunting hoist may include a third arm with at least one hook. The third arm is adapted to hold an archery bow or weapon for hunting. The hoist can include a rope holder. The second fastener may be telescopic.

### CROSS-REFERENCE TO RELATED APPLICATIONS

None.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood these statements are to be read in this light and not as admissions of prior art.

The field of the invention generally relates to hunting. In particular, the invention relates to a tree stand weapon rest and pulley systems for hunters.

Hunters are apt to use tree stands while hunting. There are many advantages to utilizing a tree stand. A properly placed tree stand allows a hunter to have a greater range of view, improved sightlines, and distance from other predators. The benefits of a tree stand can only be fully realized by staying in the tree stand; constantly climbing up and down to retrieve supplies creates excessive noise that scares away animals. Hunters with limited mobility may also find it burdensome to regularly climb in and out of a tree stand to retrieve supplies. Furthermore, tree stands are typically placed at a height of 20 feet above ground and higher. Climbing up and down to retrieve supplies creates a safety issue.

Current art includes tree stands and tree pulleys, but it is well known to one skilled in the art that these devices have shortcomings. U.S. Pat. No. 6,694,661 discloses a tree stand with an overhead weapon rest system but no mechanism to bring supplies up to the hunter. U.S. Pat. No. 8,231,095 discloses a rest for a hunter's bow while in a tree stand but no mechanism to bring supplies up to the hunter. U.S. Pat. No. 9,162,854 discloses a tree pulley for lifting carcasses and tree stands but no mechanism for using the pulley while in a tree stand.

Current art does not address the reality that many hunters cannot bring needed supplies up to their tree stand without leaving the stand to climb down. Furthermore, current art does not provide a solution to facilitate easy and flexible installation and removal of a pulley system to be used while in a tree stand. What is needed is a device that solves the aforementioned problems.

### SUMMARY

In view of the foregoing disadvantages in the prior art, the present invention provides an improved hunting hoist. The hoist satisfies this need for hoisting supplies up to a hunter's tree stand from a lower elevation, including support for an archery bow and easy and flexible mounting and removal.

Certain aspects of some embodiments disclosed herein are set forth below. It should be understood that these aspects are presented merely to provide the reader with a brief summary of certain forms the invention might take and that these aspects are not intended to limit the scope of the invention. The invention may encompass various aspects not set forth below.

According to some embodiments, the improved hunting hoist essentially comprises a first arm, a second arm, a third arm, a support member, a second fastener, and a pulley system.

According to one embodiment, an improved hunting hoist adapted to be mounted at an elevated location includes a first arm with a fastener at a proximal end and a distal end. The improved hunting hoist also includes a second arm, which includes a first section attached near the distal end having a first end and second end, a second fastener section engaging the first end, and a pulley system affixed to the improved hunting hoist.

According to one embodiment, the first arm may also further include at least one rope holder.

According to one embodiment, the first arm may also include a tubular member defining a passage therethrough.

According to one embodiment, the fastener and second fastener may also be adapted to connect to a support structure.

According to one embodiment, the second fastener may also include at least one torque handle.

According to one embodiment, the second fastener may also be telescopic.

According to one embodiment, the tightener may also be adapted to releasably affix the second fastener at a desired length.

According to one embodiment, the hoist may also include a third arm attached to the hoist near the distal end of the first arm and include at least one primary hook.

According to one embodiment, the hoist may also include where the first arm has at least one pulley mounted within the tubular member.

According to one embodiment, the hoist may also include where the fastener and second fastener are a threaded screw.

According to one embodiment, the hoist may also include where the primary hook is adapted to hold an archery bow.

According to one embodiment, the hoist may also include where the third arm further includes a second hook. Other technical features may be readily apparent to one skilled in the art from the following figures, descriptions, and claims.

According to one embodiment, the improved hunting hoist includes a first arm with a proximal end, a distal end, a mounted pulley system, and a fastener extending outwardly from the proximal end, a second arm rotatably attached near the distal end and includes a tightener, a second fastener includes at least one torque handle and slidingly engaged to the second arm, and a third arm rotatably attached to the first arm near the distal end and includes a primary hook attached to the end opposite the distal end.

According to one embodiment, the improved hunting hoist includes a tubular first arm with a pulley system, a proximal end, and a distal end, the proximal end having a threaded fastener, the pulley system mounted to the first arm, a tubular second arm rotatably attached near the distal end includes a first end, and a second end, the first end having a threaded second fastener extending outwardly therefrom, the second fastener is telescopic and includes at least one torque handle, a third arm rotatably attached to the distal end includes a second hook and an ancillary arm attached to the end opposite the distal end, the ancillary arm includes a primary hook. The hoist also includes a pulley system mounted to the first arm.

According to another embodiment, the improved hunting hoist comprises a first arm, a second arm, a third arm, a support member, and a pulley system. The first arm comprises an elongated body, a proximal end, and a distal end. The proximal end has a fastener extending outwardly from the elongated body. The second arm comprises an elongated body, a first end, and a second end. The first end of the second arm has a second fastener extending outwardly from the elongated body. The third arm comprises an elongated body and a primary hook. The third arm is rotatably attached to the first arm near the distal end of the first arm. The support member is attached to the first arm near the distal end and the second end of the second arm. The pulley system is fixated on the proximal end of the first arm.

According to another embodiment, the improved hunting hoist comprises a first arm, a second arm, a third arm, a support member, and a pulley system. The first arm comprises an elongated body, a proximal end, and a distal end. The proximal end has a fastener extending outwardly from the proximal end. The second arm comprises an elongated body, a first end, and a second end. The first end has a second fastener extending outwardly from the elongated body. The second fastener is telescopic and comprises one or more torque handles. The third arm comprises an elongated body, a second hook, and an ancillary arm. The ancillary arm comprises a primary hook. The primary hook is adapted to hold to an archery bow. The third arm is rotatably attached to the first arm near the distal end of the first arm. The support member is attached to the first arm near the distal end and attached to the second arm near the second end. The pulley system is fixated on the first arm.

Still, other aspects, examples, and advantages of these exemplary aspects and examples are discussed in detail below. Moreover, it is to be understood that both the foregoing information and the following detailed description are merely illustrative examples of various aspects and are intended to provide an overview or framework for understanding the nature and character of the claimed aspects. The invention's additional features will be described hereinafter and which will form the subject matter of the claims attached.

### BRIEF DESCRIPTION OF THE DRAWINGS

These and other features, aspects, and advantages of the present invention will become better understood with regard to the following description, appended claims, and accompanying drawings where:

FIG. 1 is a perspective view of the improved hunting hoist in an open position;

FIG. 2 is a perspective view of the improved hunting hoist in a collapsed position;

FIG. 3 is a side view of the improved hunting hoist in a collapsed position;

FIG. 4 is a second side view of the improved hunting hoist in a collapsed position;

FIG. 5 is a bottom perspective view of the improved hunting hoist in a collapsed position;

FIG. 6 is a side view of the improved hunting hoist in an open position and inserted into a tree;

FIG. 7 is a top view of the improved hunting hoist in an open position; and

FIG. 8 is a perspective view of the improved hunting hoist in an open position and inserted into a tree.

### DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming but would nevertheless be a routine undertaking of design, fabrication, and manufacture for those of ordinary skill having the benefit of this disclosure.

When introducing elements of various embodiments, the articles “a,” “an,” “the” and “said” are intended to mean that there are one or more of the elements. The terms “comprising,” “including,” “having,” and grammatical equivalents thereof are intended to be inclusive and mean that there may be additional elements other than the listed elements.

Moreover, any use of “top,” “bottom,” “above,” “below,” other directional terms, and variations of these terms is made for convenience but does not require any particular orientation of the components.

The term “at least” followed by a number is used herein to denote the start of a range beginning with that number (which may be a range having an upper limit or no upper limit, depending on the variable being defined). For example, “at least 1” means 1 or more than 1.

The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%.

When in this specification, a range is given as “(a first number) to (a second number)” or “(a first number)−(a second number),” this means a range whose lower limit is the first number and whose upper limit is the second number. For example, 25 to 100 mm means a range whose lower limit is 25 mm, and whose upper limit 100 mm.

“Fastener” refers to an engagement tool for mating two structures. This can include engagement systems, such as plate and tie systems, screws, or nails. However, as disclosed herein, a fastener consists of standard attachment means such as a screw.

“Hunter” refers to one skilled in the art of hunting game. Hunters of the type described herein may be skilled in the art of archery and commonly perch on a tree stand above ground for hunting. However, hunters, as disclosed herein, should not be limited to only those skilled in the art of archery but may also include rifle hunting.

“Pulley system” refers to a wheel with an appropriately shaped rim to carry a rope, or the like, to transmit power or motion. Pulley systems, as disclosed herein, can include single fixed wheel and axle pulley systems, moveable pulley systems, compound pulley systems, block and tackle pulley systems, or a combination of one or more pulley systems. The pulley system can also be motorized or manually driven.

“Rope,” as disclosed herein, can include a belt, a vee belt, a notched belt, a chain, or the like. A rope also includes a combination of one or more of the rope variations described.

“Weapon” refers to a hunting tool designed or used primarily for hunting game. Common weapons include an archery bow and a rifle.

LISTING OF DRAWING ELEMENTS

| | |
|---|---|
| 100 | improved hunting hoist |
| 102 | first arm |
| 104 | proximal end |
| 106 | distal end |
| 108 | fastener |
| 110 | hinge |
| 112 | second arm |
| 114 | tightener |
| 116 | second fastener |
| 118 | torque handle |
| 120 | first end |
| 122 | second end |
| 124 | third arm |
| 126 | primary hook |
| 128 | ancillary arm |
| 130 | second hook |
| 132 | support member |
| 134 | pulley system |
| 136 | rope |
| 302 | hinge |
| 304 | hinge |
| 602 | tree |
| 702 | hunter |
| 704 | hunter's area |
| 802 | rope holder |

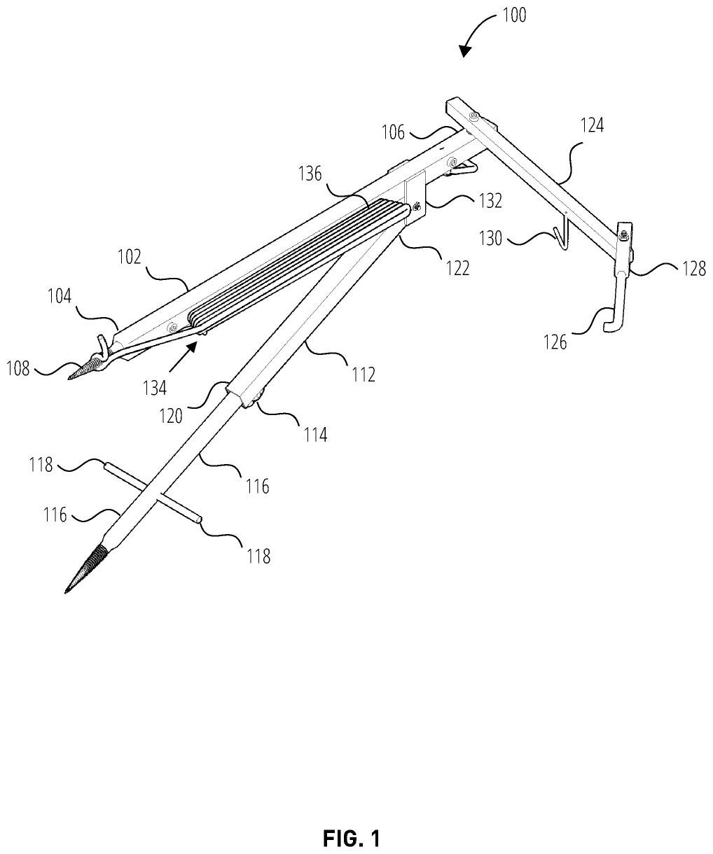

Turning to the present figures, FIG. 1 through FIG. 5 display the improved hunting hoist 100. The improved hunting hoist 100 is preferably made of a strong, durable material such as a metal or alloy. FIG. 1 is a perspective view of a preferred embodiment of the improved hunting hoist 100 in an open position. The improved hunting hoist 100 generally comprises a first arm 102, a second arm 112, a third arm 124, a second fastener 116, and a pulley system 134.

The first arm 102 has an elongated body that is square tube in shape and runs the length of the improved hunting hoist 100. The first arm 102 comprises a proximal end 104, a distal end 106, a support member 132, and a fastener 108. The fastener 108 is affixed to the proximal end 104 of the first arm 102 and extends outwardly. The fastener 108 is a threaded screw. A support member 132 is connected to the first arm 102 near the distal end 106. The support member 132 is connected to the second arm 112 near the second end 122 of the second arm 112.

The second arm 112 has a square tubular body and comprises a first end 120, a second end 122, and a tightener 114. The second arm 112 is rotatably attached to the support member 132 near the second end 122. It should be appreciated that the second arm can be rotatably attached by a ball joint, hinge, or other method known to one skilled in the art. The tightener 114 is positioned near the first end 120. The tightener 114 positions the second fastener 116 to a desired length and holds the second fastener 116 in place.

The second fastener 116 is adapted to be engaged by the tightener 114 of the second arm 112. The second fastener 116 is attached to the first end 120 by the tightener 114 and extends outwardly from the body of the second arm 112. It has an elongated body, and a pair of torque handles 118. The torque handles 118 are affixed near one end of the second fastener 116. One end of the fastener 108 is a threaded screw. The torque handles 118 are used to rotate the second fastener 116.

In a preferred embodiment, the second fastener is made of a metal or alloy. The torque handles 118 may be thermoplastic for weight reduction of the improved hunting hoist 100.

Similar to the first arm 102 and second arm 112, the third arm 124 has an elongated square tubular body. The third arm 124 comprises an ancillary arm 128, a primary hook 126, and a second hook 130. The ancillary arm 128 is rotatably affixed to the third arm 124 at the end opposite the distal end 106. The primary hook 126 is attached to the opposite end, not rotatably affixed to the third arm 124. The second hook 130 is attached to the third arm 124. It should be noted that the third arm 124 may be removed to reduce size and weight or for an alternate purpose. The primary hook 126 and second hook 130 are preferably made of a strong, durable material such as a metal or alloy; however, primary hook 126 and second hook 130 may be thermoplastic for weight savings.

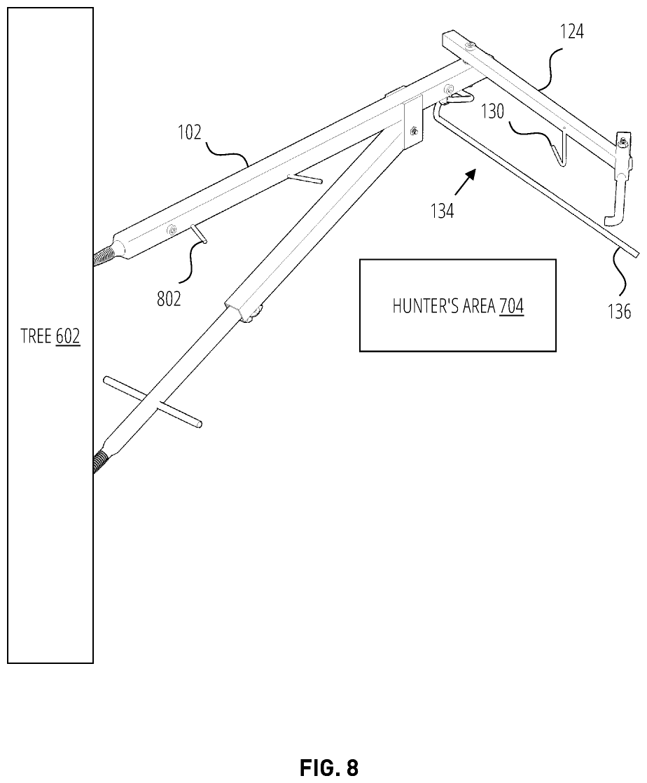

A pulley system 134 is affixed to the first arm 102. The pulley system 134 generally comprises a rope 136 and a rope holder 802 (more clearly shown in FIG. 8). The pulley system 134 is internally housed in the first arm 102, with the rope 136 affixed to the outside. When the pulley system 134 is not used, the rope 136 can be securely wrapped for convenient storage.

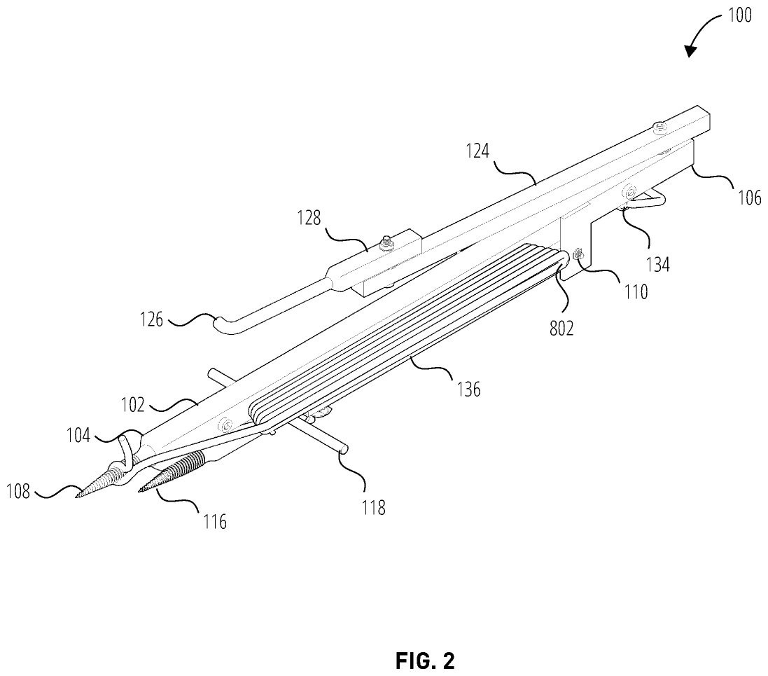

FIG. 2-FIG. 5 show the improved hunting hoist 100 in a closed position. FIG. 2 is a perspective view of the improved hunting hoist 100. It should be appreciated that the improved hunting hoist 100 can be collapsed in a close position, as shown for easy transportation.

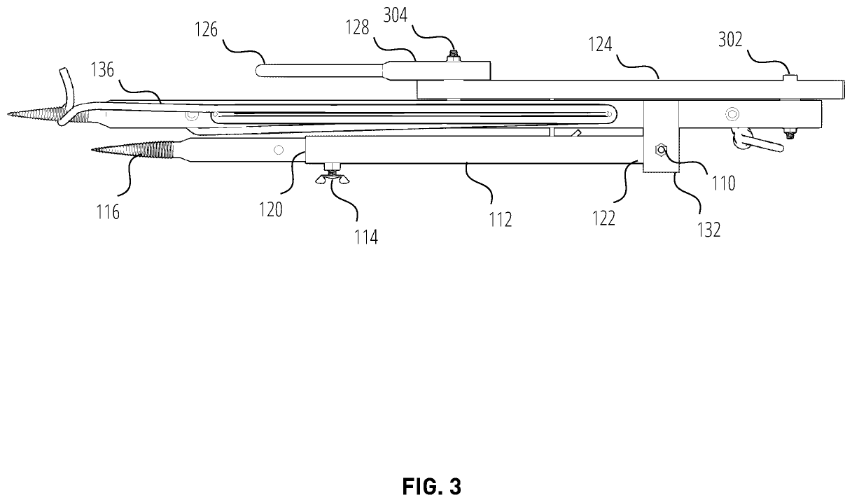

FIG. 3 is a side view of the improved hunting hoist 100. The hinge 110 is more clearly shown. The hinge 110 rotates the second arm 112 to a desired angle. Similarly, the hinges 302 and 304 are used to rotate the third arm 124 and ancillary arm respectively to a desired position.

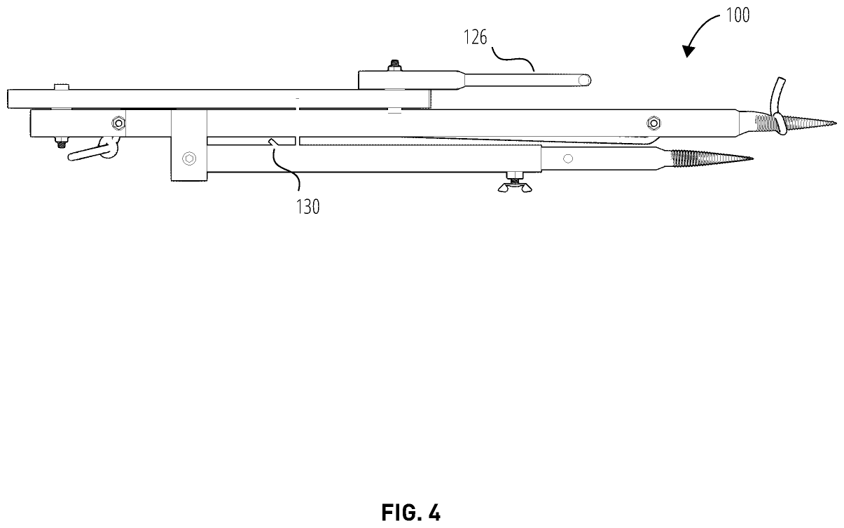

FIG. 4 is a second side view of the improved hunting hoist 100. In alternate embodiments of the improved hunting hoist 100, the primary hook 126 may be oriented to face in the opposite direction.

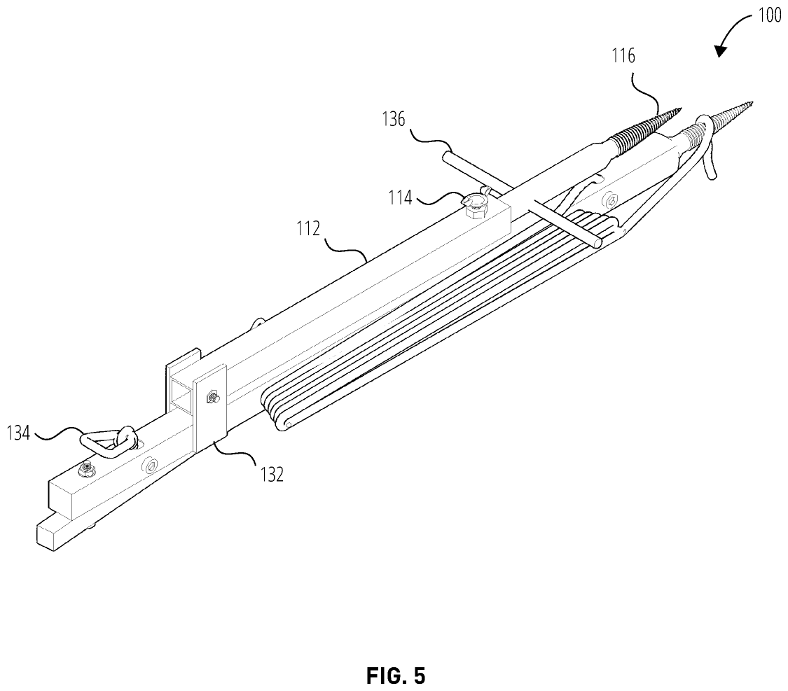

FIG. 5 is a perspective view from the bottom of the improved hunting hoist 100 to more clearly show the second arm 112, fastener 108, and pulley system 134.

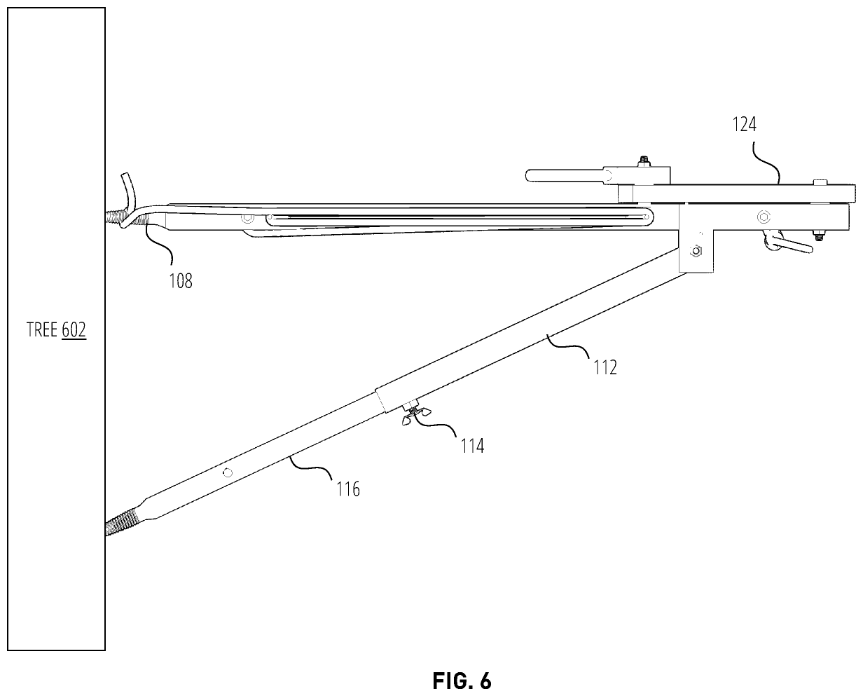

The fastener 108 and second fastener 116 are for securing the improved hunting hoist 100 to a support structure such as a tree. The fastener 108 and second fastener 116 are sufficiently tapered, threaded, and sized for engagement with a tree. The fastener 108 can be made of a sufficiently rigid material such as metal, similar to the second fastener 116. In an alternate embodiment of the invention, one or both of the fasteners, fastener 108 and the second fastener 116, can be a plate and tie system. This is clearly shown in the side view of FIG. 6, which shows the improved hunting hoist 100 engaged to a tree 602. The improved hunting hoist 100 is primarily engaged with the tree 602 by the fasteners 108, and 116. It should be appreciated that the second arm 112 has many degrees of freedom and can rotate to properly accommodate a variety of trees 602.

Furthermore, the second fastener 116 is adapted to telescope into the elongated body of the second arm 112 and is adjusted to a proper length to be held in place with a tightener 114.

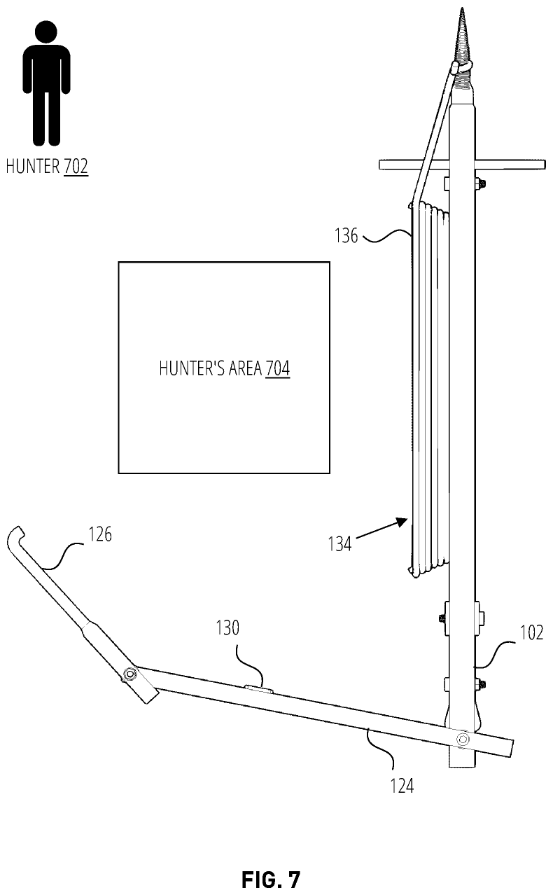

FIG. 7 is a top view of the improved hunting hoist 100 to show a hunter's area 704. The improved hunting hoist 100 improves safety and comfort for a hunter 702 as there are specific rest for a weapon.

It should be appreciated that the hunter 702 can rest a weapon, such as an archery bow or a rifle, at the ready by the primary hook 126 and second hook 130. The third arm 124 and ancillary arm 128 form a swing arm that can be adjusted to varying angles. The primary hook 126 is adapted to engage a rifle by its shoulder strap safely, or it can hold an archery bow. One skilled in the art may use the primary hook 126 to rest various other weapons for hunting. The second hook 130 can engage a tether attached to the weapon, a secondary safety mechanism. When the improved hunting hoist 100 is viewed from above in FIG. 7, the invention's comfortable positioning about the hunter 702 is apparent. The third arm 124 and ancillary arm 128 are rotatably adjustable to open or close at an angle desired by the hunter 702.

FIG. 8 is a perspective view of the improved hunting hoist 100 inserted into a tree 602, and the rope 136 is in an active position. The rope holders 802 previously described are more clearly shown here when the rope 136 is in the active position. The rope 136 is secured to the improved hunting hoist 100 at one end while the other end is free to be secured to supplies. One skilled in the art could secure the rope to an alternative object or suspend the game using the pulley system 134 and rope 136.

When the rope 136 is actively being used the, rope holders 802 can be used to hold other items that the hunter desires.

The improved hunting hoist 100 is configured for hoisting supplies and other items, such as a weapon, from a lower ground level to a higher level. This is achieved by securing the improved hunting hoist 100 to tree at an elevation higher than ground level. First, the hunter pierces a tree at a desired first point and rotates the improved hunting hoist 100 about the fastener 108 to securely engage the fastener 108. Second, the second arm 112 is pulled open to a desired angle, and the fastener 108 is loosened so that the second fastener 116 is free to telescope to a desired length. The hunter selects a desired second point to engage the second fastener 116. The torque handle 118 is used to rotate the second fastener 116 and securely engage it. The tightener safely secures the second fastener at a desired length. Once the improved hunting hoist 100 is properly affixed to a tree, the hunter can open the third arm 124 to a desired angle and rest the weapon of their choosing on the primary hook 126 and second hook 130. Alternatively, once the improved hunting hoist 100 is securely fastened to a tree, the hunter can unravel the rope 136 and use the pulley system 134 to hoist supplies.

The improved hunting hoist 100 is not dependent on the order in which the steps described are performed. For example, the rope 136 can be unraveled from the pulley system 134 first and secured to supplies or a weapon at ground level. Once the hunter reaches a desired higher level, the pulley system 134 can be engaged to raise the previously secured supplies or weapon to a desired height.

When hunting in a tree stand safety is of the utmost importance for a hunter. The improved hunting hoist enhances hunter safety by providing a secure and hands-free rest for the weapon and keeping it at the ready. Furthermore, the improved hunting hoist reduces the need to climb up and down or the need to carry excessive supplies when climbing the tree.

It should be appreciated that alternate embodiments of the improved hunting hoist include replacing the first arm, second arm, and third arm with round tubes for better ergonomics. In some embodiments, a hunter may prefer the rope to be affixed to a different side of the first arm or be internally secured. The fastener may be telescopic, such as the second fastener. The second fastener may include only a torque handle for rotating the fastener.

Although the present invention has been described in considerable detail with reference to certain preferred versions thereof, other versions are possible. Therefore, the spirit and scope of the appended claims should not be limited to the description of the preferred versions contained herein.

What is claimed is:

1. An improved hunting hoist adapted to be mounted at an elevated location, the hoist comprising:
(a) a first arm comprising
(i) a fastener at a proximal end, and
(ii) a distal end;
(b) a second arm comprising
(i) a first section attached near the distal end having a first end and second end,
(ii) a second fastener section engaging the first end, and
(c) a pulley system affixed to the improved hunting hoist.

2. The hoist of claim 1, wherein the first arm further comprising at least one rope holder.

3. The hoist of claim 1, wherein the first arm comprises a tubular member defining a passage therethrough.

4. The hoist of claim 3, wherein the first arm has at least one pulley mounted within the tubular member.

5. The hoist of claim 1, wherein the fastener and second fastener are adapted to connect to a support structure.

6. The hoist of claim 5, wherein the fastener and second fastener are a threaded screw.

7. The hoist of claim 1, wherein the second fastener comprises at least one torque handle.

8. The hoist of claim 1, wherein the second fastener is telescopic.

9. The hoist of claim 1, wherein the first section is rotatably attached.

10. The hoist of claim 1, wherein the tightener is adapted to releasably affix the second fastener at a desired length.

11. The hoist of claim 1, further comprising a third arm attached to the hoist near the distal end of the first arm comprising at least one primary hook.

12. The hoist of claim 11, wherein the primary hook is adapted to hold an archery bow.

13. The hoist of claim 11, wherein the third arm further comprising a second hook.

14. An improved hunting hoist, the hoist comprising:
a first arm comprising a proximal end, a distal end, a mounted pulley system, and a fastener extending outwardly from the proximal end;
a second arm rotatably attached near the distal end and comprising a tightener;
a second fastener comprising at least one torque handle and slidingly engaged to the second arm; and
a third arm rotatably attached to the first arm near the distal end and comprising a primary hook attached to the end opposite the distal end.

15. An improved hunting hoist, the hoist comprising:
a tubular first arm comprising a pulley system, a proximal end, and a distal end,
the proximal end comprising a threaded fastener,
the pulley system mounted to the first arm;
a tubular second arm rotatably attached near the distal end comprising a first end, and a second end,
the first end comprising a threaded second fastener extending outwardly therefrom,
the second fastener is telescopic and comprising at least one torque handle; and
a third arm rotatably attached to the distal end comprising a second hook, and
an ancillary arm is attached to the end opposite the distal end, comprising a primary hook.
